(19) United States
(12) Patent Application Publication
(10) Pub. No.: US 2009/0273513 A1
(43) Pub. Date: Nov. 5, 2009

(54) METHOD OF DYNAMICALLY OPTIMIZING THE UPDATE RATE OF GPS OUTPUT DATA

(75) Inventor: Yi-Ping HUANG, Hsinchu City (TW)

Correspondence Address: PATENTTM.US, P. O. BOX 82788, PORTLAND, OR, 97282-0788, US

(73) Assignee: SKYTRAQ TECHNOLOGY INC., Hsinchu City (TW)

(21) Appl. No.: 12/113,921

(22) Filed: May 1, 2008

(51) Int. Cl. G01S 1/00

(52) U.S. Cl. 342/357.12; 342/357.13

(57) ABSTRACT

A method of dynamically optimizing the update rate of GPS output data has acts of setting relationships between different moving speeds and different update rates; sensing a current moving speed of a GPS receiver; determining a update rate corresponding to the current moving speed of the GPS receiver; and outputting GPS position and velocity data according to the determined update rate. Since the update rate is variable in view of moving speed, a moving map showing GPS information remains a smooth display.

### BACKGROUND OF THE INVENTION

1. Field of the Invention

The present invention relates to a method of dynamically optimizing the update rate of GPS output data, and particularly to a method that automatically adjusts the position and velocity update rate according to the moving speed of the GPS receiver to ensure a smooth moving map display.

2. Description of the Prior Arts

One of GPS-based applications consists of a Bluetooth-GPS receiver and a Bluetooth-enabled personal digital assistance (PDA). The Bluetooth-GPS receiver obtains power from a rechargeable battery and normally outputs position and velocity data at 1 Hz update rate. A processor within the Bluetooth-GPS receiver is desired to run at a lower clock frequency to reduce power consumption and to prolong the battery life.

The Bluetooth-enabled PDA wirelessly receives the position and velocity data and accordingly generates a dynamic moving map showing geographical information around the GPS receiver. The moving map displayed on the PDA is continuously updated based on the update rate, and can have a smooth movement if the GPS receiver is moving at a relative slow speed.

As the GPS receiver travels at a higher speed, a jump movement shown by the moving map becomes more significant. Altering the update rate of the processor from the original 1 Hz to a higher update rate such as 10 Hz can mitigate the jump problem. However, a constant high update rate of the processor results in higher power consumption.

### SUMMARY OF THE INVENTION

An objective of the present invention is to provide a method of dynamically optimizing the update rate of GPS output data to have an always-smooth moving map display without need of operating the GPS receiver at a high fixed update rate.

To accomplish the objective of the present invention, the method comprising the acts of setting relationships between different moving speeds and different update rates; sensing a current moving speed of a GPS receiver; determining a update rate corresponding to the current moving speed of the GPS receiver; and outputting GPS position and velocity data according to the determined update rate.

Other objectives, advantages and novel features of the invention will become more apparent from the following detailed description when taken in conjunction with the accompanying drawings.

### BRIEF DESCRIPTION OF THE DRAWINGS

FIG. 1 is an operational view of a GPS-based application having a GPS receiver and a PDA;

FIG. 2 is a flow chart of a method of dynamically optimizing the update rate of GPS output data in accordance with the present invention;

FIG. 3 is a table of relationships between moving speeds and update rates in accordance with the present invention; and

FIG. 4 is a flowchart of determining an update rate corresponding to the current moving speed in accordance with the present invention.

### DETAILED DESCRIPTION OF THE PREFERRED EMBODIMENTS

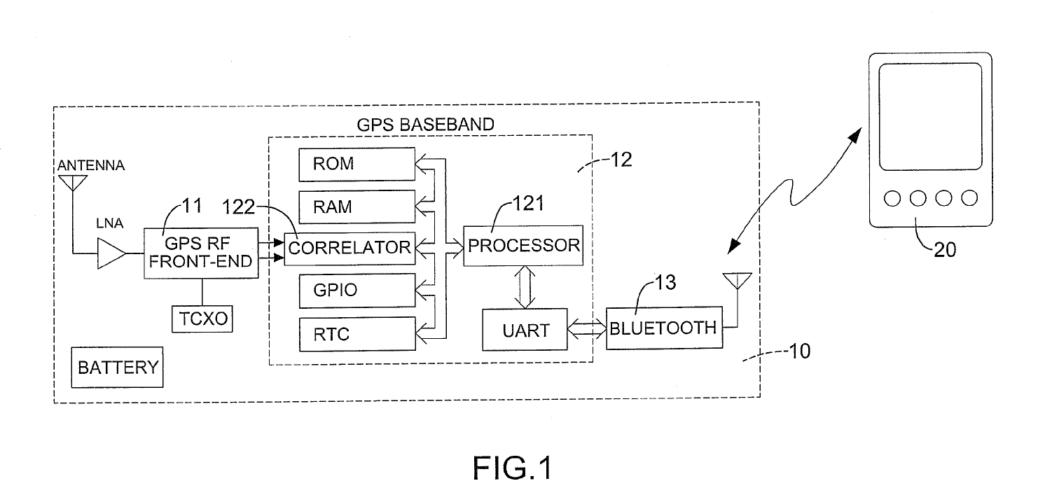

With reference to FIG. 1, one of GPS applications is taken as an example in the following description, which uses a Bluetooth-GPS receiver (10) and a Bluetooth-enabled PDA (20) to accomplish navigation objective.

The Bluetooth-GPS receiver (10) acquires power from a battery and comprises a GPS RF front-end module (11), a GPS baseband module (12) and a Bluetooth transceiver (13), wherein the GPS baseband module (12) at least has a processor (121) and a correlator (122).

The GPS receiver (10) transmits GPS position & velocity data to the Bluetooth-enabled PDA (20) for displaying a moving map on the Bluetooth-enabled PDA (20). The moving map shows calculated GPS information. The processor (121) within the GPS baseband chip (12) controls the correlator (124) to acquire and track GPS signal received by the GPS RF front-end module (11). After the GPS signal is continuously tracked by the correlator (124), snapshot measurement of the correlator counter register values at regular 1-second interval can be translated into position and velocity measurement of the GPS receiver output at 1-Hz rate. Typically the processor (121) is running at a lowest possible clock frequency to reduce power consumption of the battery.

To ensure that the moving map can be smoothly displayed on the Bluetooth-enabled PDA (20), it is desirable to have the movement on the moving map being less than a certain distance when the moving map is continuously updated per second. For instance, an acceptable maximum certain movement distance on the map is 0.5 cm. Assuming at 1 Hz update rate, 0.5 cm movement for each update on the moving map represents that a moving speed of the GPS receiver (10) is 18 km/hr. As the moving speed of the GPS receiver (10) is increased, to maintain the movement being less than 0.5 cm per update for ensuring the smoothed display on the moving map, the update rate of the processor (121) needs to be increased in relation to the increased moving speed.

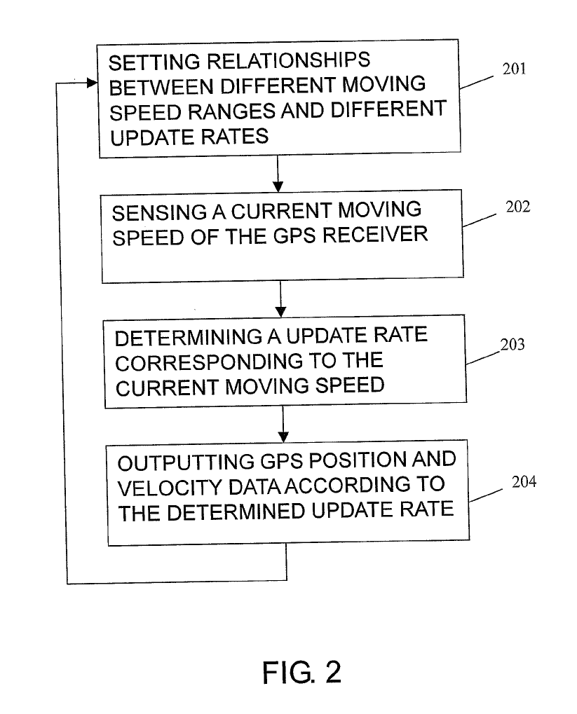

With reference to FIG. 2, the present invention provides a method for dynamically optimizing the displayed moving map of the GPS receiver. The method includes acts of setting relationships between different moving speed ranges and different update rates (201), sensing a current moving speed of the GPS receiver (10) (202), determining a update rate corresponding to the current moving speed (203), and outputting GPS position and velocity data according to the determined update rate (204). A program executed by the GPS receiver (10) can implement the foregoing steps.

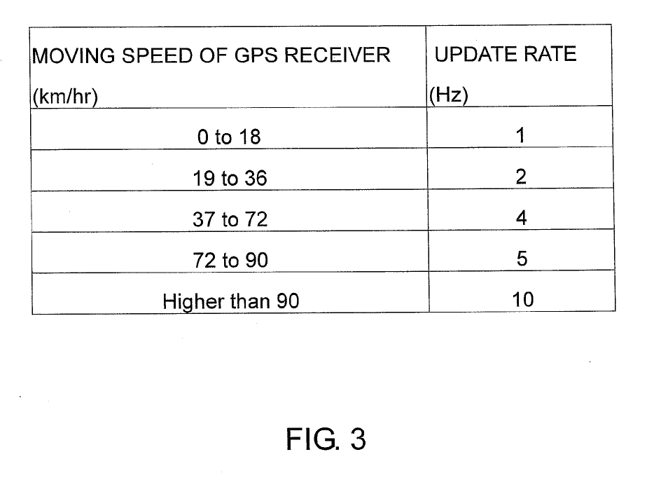

With further reference to FIG. 3, the act of setting relationships between different moving speed ranges and different update rates (201) may create a look-up table with respect to moving speeds and update rates of the processor (121). Basically, the update rates are in direct proportion to the moving speeds. For example, 1 Hz update rate corresponds to any moving speed within the range 0-18 km/hr. 2 Hz update rate corresponds to any moving speed within the range 19-36 km/hr. When the moving speed of the GPS receiver (10) is higher than 90 km/hr, 5 Hz update rate is taken.

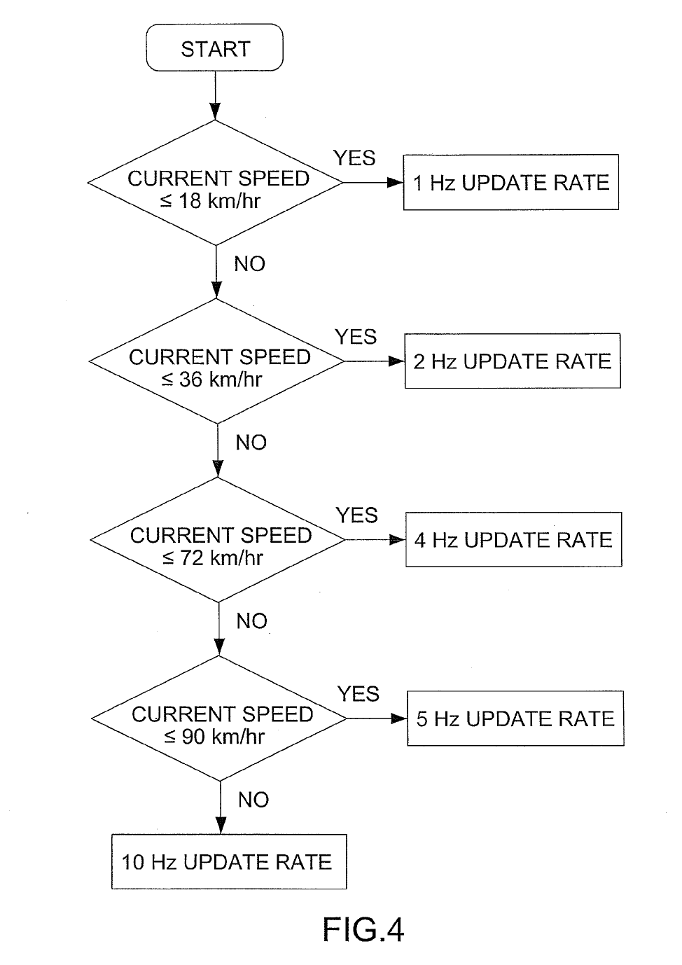

With further reference to FIG. 4, in the act of determining a update rate corresponding to the current moving speed (203), the update rate of the processor (121) is determined according to the moving speed of the GPS receiver (10), based on the created relationships in the table. The current moving speed will be sequentially compared to different values to decide which range it corresponds to. As an example, if the current moving speed is 60 km/hr, the update rate is 4 Hz.

As the update rate is increased to N Hz, the clock frequency of the processor (121) needs to be increased accordingly, rendering higher power consumption. However, since the update rate is not a fixed value, but changes adaptively as required, the processor (121) can run at a minimal clock frequency and still remain a smooth display of the moving map.

In another embodiment, the Bluetooth-GPS receiver (10) may be a passive device without the update rate decision program, but receives an external command to alter the update rate. For example, the PDA (20) has the update rate decision program and outputs a command to the Bluetooth-GPS receiver (10) to adjust the update rate.

Although the aforementioned description is based on the Bluetooth-based GPS receiver (10) and a physically separate PDA device (20) for displaying the moving map, the approach of the present invention can easily extend to applications where the GPS receiver (10) and the moving map co-exist within a same device such as a Personal Navigation Device (PND), a GPS-Embedded Smart-Phone and so forth.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A method of dynamically optimizing the update rate of GPS output data, the method comprising:
setting relationships between different moving speeds and different update rates;
sensing a current moving speed of a GPS receiver;
determining a update rate corresponding to the current moving speed of the GPS receiver; and
outputting GPS position and velocity data according to the determined update rate.

2. The method as claimed in claim 1 further comprising an act of receiving the position and velocity data and accordingly updating a moving map showing GPS information.

3. The method as claimed in claim 1, wherein the update rates are in direct proportion to the moving speeds.

4. The method as claimed in claim 2, wherein the update rates are in direct proportion to the moving speeds.
